(19) United States
(12) Patent Application Publication
(10) Pub. No.: US 2005/0282285 A1
(43) Pub. Date: Dec. 22, 2005

(54) Strategy for controlling NOx emissions and ammonia slip in an SCR system using a nonselective NOx/NH3

(75) Inventors: Subbaraya Radhamohan, Novi, MI (US); Michael Eugene Crane, Gray, TN (US)

Correspondence Address: PAUL V. KELLER, LLC, 4585 LIBERTY RD., SOUTH EUCLID, OH, 44121, US

(73) Assignee: Eaton Corporation, Cleveland, OH (US)

(21) Appl. No.: 10/872,659

(22) Filed: Jun. 21, 2004

(51) Int. Cl. G01N 35/08

(52) U.S. Cl. 436/55

(57) ABSTRACT

One aspect of the invention relates to controlling the ammonia feed rate to an SCR reactor using a NOx sensor cross-sensitive to ammonia. The sensor, positioned downstream of the reactor, is interrogated by introducing a pulse in the ammonia feed rate. A positive response to a positive pulse indicates ammonia slip. A negative response to a positive pulse indicates NOx breakthrough. Another aspect of the invention related to a combination of feed-back and feed-forward control. Upon detecting ammonia slip, the controller enters into an ammonia slip recovery mode in which the ammonia feed rate is reduced for a period to restore the reactor's ammonia or NOx buffering capacity. After the recovery period, feed-forward control is restored, optionally with an updated control objective. A further aspect of the invention relates to a learning probabilistic model for feed-forward control trained according to the occurrence or non-occurrence of NOx breakthrough and ammonia slip.

### FIELD OF THE INVENTION

The present invention relates to the field of pollution control devices for internal combustion engines.

### BACKGROUND OF THE INVENTION

NOₓ emissions from vehicles with internal combustion engines are an environmental problem recognized worldwide. Several countries, including the United States, have long had regulations pending that will limit NOₓ emissions from vehicles. Manufacturers and researchers have put considerable effort toward meeting those regulations. In conventional gasoline powered vehicles that use stoichiometric fuel-air mixtures, three-way catalysts have been shown to control NOₓ emissions. In diesel powered vehicles and vehicles with lean-burn gasoline engines, however, the exhaust is too oxygen-rich for three-way catalysts to be effective.

Several solutions have been proposed for controlling NOx emissions from diesel powered vehicles and lean-burn gasoline engines. One set of approaches focuses on the engine. Techniques such as exhaust gas recirculation and homogenizing fuel-air mixtures can reduce NOx emissions. These techniques alone, however, will not eliminate NOx emissions. Another set of approaches remove NOx from the vehicle exhaust. These include the use of lean-burn NOₓ catalysts, NOₓ adsorber-catalysts, and selective catalytic reduction (SCR).

Lean-burn NOx catalysts promote the reduction of NOx under oxygen-rich conditions. Reduction of NOx in an oxidizing atmosphere is difficult. It has proved challenging to find a lean-burn NOₓ catalyst that has the required activity, durability, and operating temperature range. Lean-burn NOₓ catalysts also tend to be hydrothermally unstable. A noticeable loss of activity occurs after relatively little use. Lean burn NOx catalysts typically employ a zeolite wash coat, which is thought to provide a reducing microenvironment. The introduction of a reductant, such as diesel fuel, into the exhaust is generally required and introduces a fuel economy penalty of 3% or more. Currently, peak NOx conversion efficiency with lean-burn catalysts is unacceptably low.

NOx adsorber-catalysts alternately adsorb NOx and catalytically reduce it. The adsorber can be taken offline during regeneration and a reducing atmosphere provided. The adsorbant is generally an alkaline earth oxide adsorbant, such as BaCO₃ and the catalyst can be a precious metal, such as Ru. A drawback of this system is that the precious metal catalysts and the adsorbant may be poisoned by sulfur.

SCR involves using ammonia as the reductant. The NOx can be temporarily stored in an adsorbant or ammonia can be fed continuously into the exhaust. SCR can achieve NOx reductions in excess of 90%. One concern relates to controlling the ammonia feed rate. The NOx flow rate and demand for ammonia vary widely and rapidly during engine operation. Too little ammonia can lead to NOx breakthrough and too much ammonia can result in ammonia release, which is an environmental hazard.

U.S. Pat. No. 4,963,332 describes a control scheme for SCR reduction of NOx in flue gases where the NOx concentration and mass flow rate are measured upstream of the reactor and NOx concentration is also measured downstream of the reactor. The mole ratio of ammonia feed to NOx is adjusted based on the downstream NOx concentration. U.S. Pat. No. 4,751,054 describes a similar approach using an ammonia sensor.

U.S. Pat. No. 5,522,218 describes a control scheme for NOx reduction in diesel exhaust where the reductant is supplied according to a feed forward control scheme based on engine operating conditions and exhaust gas temperature. The reductant supply rate is determined by a table look-up.

U.S. Pat. No. 5,047,220 describes a feed-forward control scheme to establish a supply rate of reductant at 90% of estimated requirements and a feed-back loop to set a trim signal establishing a supply rate for the balance of the required reductant.

U.S. Pat. No. 4,314,345 describes a feed forward control scheme for NOx reduction in flue gases in which the ammonia supply rate is adjusted during exhaust gas temperature transients to account for temperature-dependent increases and decreases in the amount of ammonia adsorbed in the SCR reactor.

U.S. Pat. No. 5,833,932 describes an SCR reactor for treating diesel exhaust, the reactor having a reductant storage capacity that increases along the reactor's length in the direction of flow. The low capacity up front is said to enhance light-off performance. The large capacity downstream is intended to provide a buffer against sudden increases in demand. It is also said that during transients that involve a sudden temperature increase, reductant desorbed at the front of the reactor can be captured near the back.

U.S. Pat. No. 5,785,937 describes a feed-forward control system for supplying an SCR reactor in a diesel exhaust system. The reducing agent is sometimes fed super-stoichiometrically and sometimes fed sub-stoichiometrically during transients with the objective of maintaining an optimal level of adsorbed ammonia in the SCR reactor.

U.S. Pat. No. 5,643,536 describes a feed-back control system for supplying ammonia to an SCR reactor in a diesel exhaust system wherein the control system is said to measure the thickness of a reaction zone. The thickness of the reaction zone is the depth within a porous wall of the catalyst at which the ammonia concentration passes through a minimum. The feed rate of ammonia is adjusted to seek a targeted reaction zone thickness.

U.S. Pat. No. 5,628,186 describes a feed-forward control system for supplying ammonia to an SCR reactor in a diesel exhaust system wherein the feed rate is adjusted to account for the rate of adsorption or desorption of reductant from the catalyst bed.

After reviewing many of the above cited references, U.S. Pat. No. 6,662,553 concludes “there are no commercially available NOx sensors which have the response time needed for vehicular applications” and that “any SCR control system for mobile applications will necessarily be open loop.”

U.S. Pat. No. 6,455,009 describes a feed-back control system for supplying ammonia to an SCR reactor wherein feedback is provided by a sensor cross-sensitive to ammonia and NOx. The feed rate of ammonia is continuously cycled. When the detection signal is found to be increasing while ammonia feed rate is also increasing, the feed rate is switched to a decreasing trend, optionally following a step decease. When the signal again begins to rise, the feed rate trend is again reversed.

U.S. Pat. No. 6,625,975 describes a system for supplying ammonia to an SCR reactor in a diesel exhaust system wherein a sensor that is cross-sensitive to oxidizable species, but not NOx, is used to measure ammonia concentration for feed-back control. Oxidizable species other than ammonia are removed prior to the SCR reactor by an oxidative catalytic converter.

While a great deal of effort has already been expended in this area, there continues to be a long felt need for reliable, affordable, and effective systems for controlling ammonia supply rates to SCR reactors in diesel exhaust systems.

### SUMMARY OF THE INVENTION

The following presents a simplified summary in order to provide a basic understanding of some aspects of the invention. This summary is not an extensive overview of the invention. It is intended neither to identify key or critical elements of the invention nor to delineate the scope of the invention. Rather, the primary purpose of this summary is to present some concepts of the invention in a simplified form as a prelude to the more detailed description that is presented later.

One aspect of the invention relates to a system and method of controlling the ammonia feed rate to an SCR reactor. The method is adapted to systems that use NOx sensors that are cross-sensitive to ammonia. According to this aspect of the invention, an NOx sensor positioned downstream of the reactor is interrogated by introducing a pulse in the ammonia feed rate. A positive response to a positive pulse indicates ammonia slip. A negative response to a positive pulse indicates NOx breakthrough. In either case, the control system can respond by adjusting the ammonia feed rate.

Another aspect of the invention is related to systems and methods of controlling an SCR reactor with a combination of feed-back and feed-forward control. In one embodiment, upon detecting ammonia slip, the controller enters into an ammonia slip recovery mode in which the ammonia feed rate is temporarily reduced from the amount determined by the feed forward control or stopped altogether to substantially reduce the amount of ammonia and/or increase the amount of NOx adsorbed in the reactor. In another embodiment, upon detecting NOx breakthrough, the controller enters into an NOx breakthrough recovery mode in which the ammonia feed rate is temporarily increased from the amount determined by the feed forward control to substantially increase the amount of ammonia and/or reduce the amount of NOx adsorbed in the reactor. A related aspect of the invention provides for experimental measurement of the SCR reactor's adsorption capacity. The recovery modes can include adjusting the control objective of the feed-forward control. After a recovery period, feed-forward control is restored. These approaches restore the reactor's buffering capacity after feed-back correction and thus reduce the frequency with which feed-back correction is necessary.

A further aspect of the invention related to systems and methods of controlling an SCR reactor with feed-forward control involving a learning probabilistic model. The system includes apparatus for detecting ammonia slip and/or NOx breakthrough. The occurrence or non-occurrence of these phenomena provide training data for the model.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is an illustration of possible responses to an ammonia pulse of a cross-sensitive NOx detector;

FIG. 2 illustrates the response to increasing ammonia feed rate of a cross-sensitive NOx detector downstream of an SCR reactor;

FIG. 3 is a finite state diagram of an SCR reactor controller;

FIG. 4 is a decision graph for determining an ammonia to NOx mole ratio;

FIG. 5 is a flow chart of a procedure for generating training examples;

FIG. 6 is a schematic illustration of a system according to one aspect of the present invention;

FIG. 7 illustrates a monolith SCR reactor;

FIG. 8 illustrates a packed bed SCR reactor;

FIG. 9 illustrates an SCR reactor of coated stacked screens;

FIG. 10 is a frontal view of the reactor of FIG. 8.

### DETAILED DESCRIPTION OF THE INVENTION

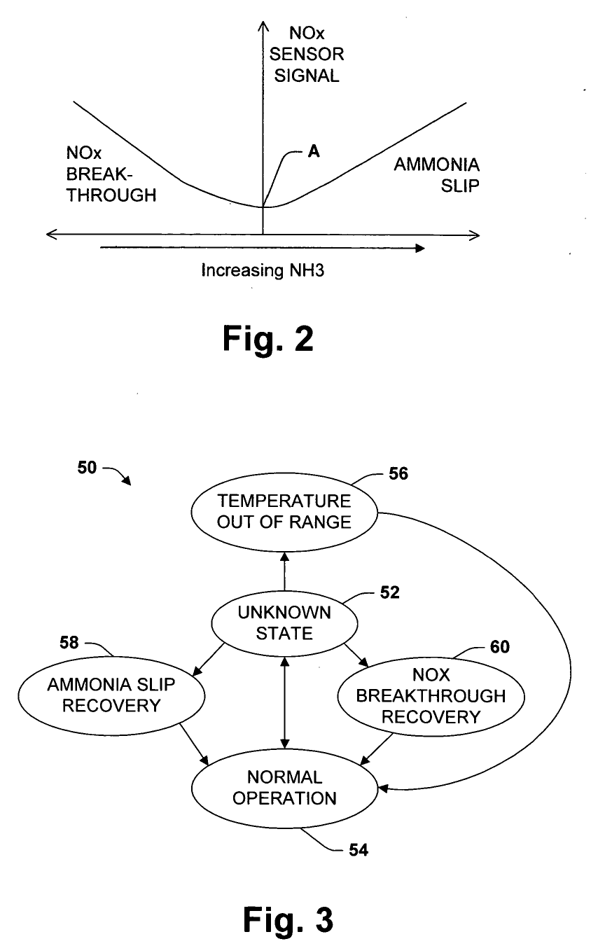

The present invention is adapted to NOx sensors that are cross sensitive to ammonia. FIG. 2 illustrates the typical response of such a sensor downstream of an SCR reactor. At low ammonia feed rates, the sensor signal is high due to unconverted NOx. This will be referred to as NOx breakthrough, which is an NOx concentration downstream the SCR reactor significantly in excess of what would be found with an optimal ammonia feed rate. As the feed rate increases towards an optimum A, the signal decreases due to reduced NOx concentration. At the optimum A, the conversion of NOx is essentially maximized, NOx concentration is near the minimum achievable, and ammonia slip is low. If the ammonia feed rate continues to increase, the detector signal begins to rise again due to unreacted ammonia escaping the reactor. A significant amount of unreacted ammonia escaping the reactor is referred to as ammonia slip.

During transient operation of a vehicle, the NOx concentration and exhaust flow rate vary widely. Feed forward control can follow many of these changes, but there are uncontrolled variables and it is likely that at some point the signal from a sensor downstream of the reactor will rise from its minimum and it will not be immediately apparent whether the cause is ammonia slip or NOx breakthrough.

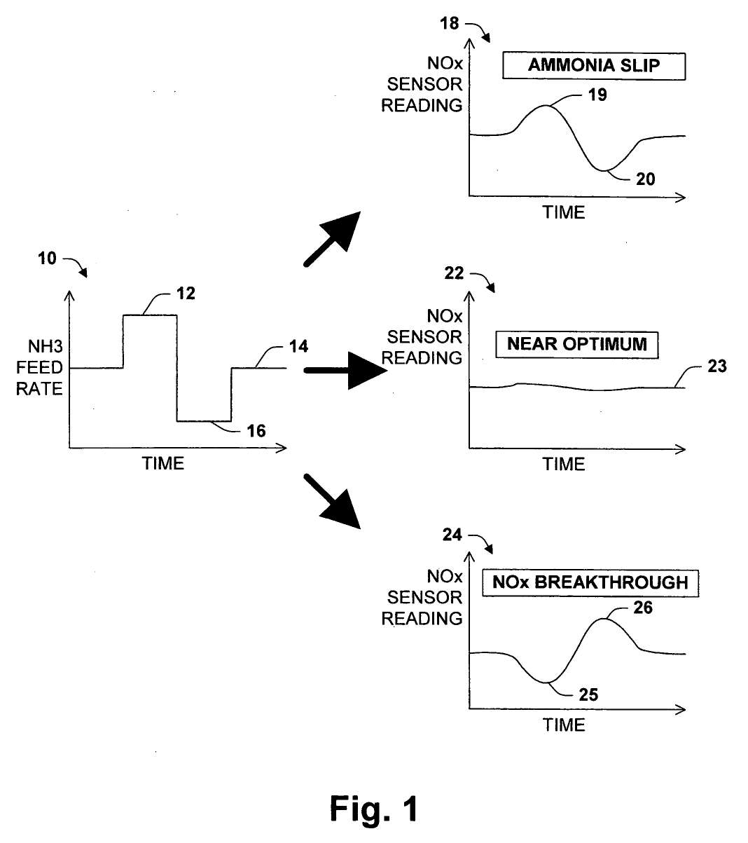

FIG. 1 illustrates how an ammonia pulse can be used to interrogate an NOx sensor with cross-sensitivity to ammonia to distinguish a state of ammonia slip from a state of NOx breakthrough. A pulse is a transient variation. The pulse is generated over a short period while the entering NOx concentration and flow rate remain relatively constant. Preferably, the pulse last no more than about one second, more preferably no more than about 0.3 seconds, still more preferably no more than about 0.1 seconds. A pulse can be an increase in the ammonia feed rate (positive pulse), a decrease in the ammonia feed rate (negative pulse), or a combination of the two. The pulse illustrated in graph 10 of FIG. 1 comprises a brief increase 12 (positive portion) above a relatively steady rate 14 followed by a brief decrease 16 (negative portion) below the steady rate 14.

The graph 18 of FIG. 1 illustrates a typical effect of the pulse on the detector signal when the SCR reactor is in a condition of ammonia slip. The positive portion 12 of the pulse results in an increase 19 in the detector signal due to a greater excess of ammonia. The negative portion 16 of the pulse results in a decrease 20 in the detector signal due to a reduction of excess ammonia. The contribution of NOx to the detector signal during ammonia slip is generally small.

The graph 22 of FIG. 1 illustrates a typical effect of the pulse on the signal when the SCR reactor is operating in its optimal range. The signal 23 shows relatively little variation. The excess ammonia provided by the positive pulse portion is adsorbed by the SCR reactor. During the negative portion of the pulse, adsorbed ammonia makes up any deficiency in the ammonia feed rate. NOx conversion remains high through the pulse.

The graph 24 of FIG. 1 illustrates a typical effect of the pulse on the signal when the SCR reactor is a condition of NOx breakthrough. The effect is approximately the inverse of the effect during ammonia slip. The positive portion 12 of the pulse results in a decrease 25 in the detector signal due to greater conversion of NOx. The negative portion 16 of the pulse results in an increase 26 in the detector signal due to a decrease in NOx conversion. The contribution of ammonia to the detector signal is generally minimal during NOx breakthrough.

The forgoing interrogation method can be used in feedback control. In one embodiment, a feedback controller has two modes, an excess ammonia mode and an excess NOx mode. In the former mode, the controller takes the sensor signal as a measure of ammonia concentration. In the latter mode, the controller takes the sensor signal as a measure of NOx concentration. Within each mode, the controller uses a conventional control scheme, for example, a combination of proportion, integral, and differential control (typically just proportional and integral). From time to time, the system interrogates the sensor with an ammonia pulse to determine which regime the controller should operate in. The interrogation can take place periodically or on the occurrence of an event. The event could be the NOx sensor passing through a critical value, or one of several critical values.

In the present disclosure, an SCR reactor can be just one of several SCR reactors in series or a segment of an SCR reactor. For example, an exhaust system may have two SCR reactors. The first reactor may use feed forward control targeted to remove 90% of the NOx, or to reduce the NOx level to a fixed target level. The second SCR reactor may use feedback control according to one or more aspects of the invention. It should also be understood that any reference to controlling the ammonia feed rate is inclusive of controlling the feed rate of an ammonia precursor, such as urea or ammonium carbomate.

FIG. 3 is a finite state machine diagram illustrating the possible use of detector interrogation by a controller and possible responses of the controller to interrogation results. The process 50 begins in normal operation 54, which preferably comprises feed forward control over the ammonia feed rate. Feed forward control is control that involves measurements and estimates other than those reflecting actual performance of the SCR reactor. Feed forward control can use any set of measurements upstream of the SCR reactor, the SCR reactor temperature, and/or estimate of one or more of NOx concentration in the exhaust, the exhaust flow rate, reaction rates in the SCR reactor, and adsorption or desorption rates for the SCR reactor. Normal operation is typically maintained until the NOx sensor gives a reading above a target level during an interval where the sensor reading is not decreasing significantly. Normal operation can also be interrupted periodically or upon the occurrence of some other condition. After normal operation, the process 50 enters the unknown state 52.

In the unknown state 52, the SCR reactor temperature is first queried to determine whether the reactor is in an appropriate temperature range for reducing NOx. If the temperature is out of range, the process 50 enters the temperature out-of-range state 56 where ammonia feed is suspended. When the temperature comes into range, the process 50 enters the normal operation state 54.

If in the unknown state 52 the SCR reactor temperature is found to be within a normal operating range, the process 50 seeks feedback regarding the status of the SCR reactor. In one embodiment, obtaining this feedback comprises interrogating an NOx sensor downstream of the SCR reactor with a pulse in the ammonia feed rate. If the response indicates ammonia slip, the process enters an ammonia slip recovery state 58. If the response indicates NOx breakthrough, the process 50 enters a NOx breakthrough recovery state 60. If the response indicates neither, the process 50 can return to the normal operation state 54. The query can be repeated if a sudden change in engine operation or other occurrence made the result of the interrogation doubtful. Where the interrogation indicated a near optimal conversion and the unknown state 52 was entered due to a high reading from the NOx sensor, the threshold for the NOx sensor can be increased.

According to one aspect of the invention, the ammonia slip recovery state 58 involves restoring the SCR reactor's buffering capacity. This buffering capacity is generally the capacity to adsorb and store excess ammonia. Alternatively, though less commonly, this buffering capacity can be the capacity to store NOx. When the reactor is saturated with ammonia, there is no capacity to store excess ammonia. Moreover, the condition of saturation can have an adverse effect on the reaction rate of NOx with ammonia due to blocking of active sites on the reactor surface. The SCR reactor's buffering capacity is restored by reducing the ammonia feed rate relative to the feed forward rate, preferably stopping the ammonia feed altogether.

Preferably, the controller estimates the adsorption capacity of the SCR reactor and suspends or lowers the ammonia feed rate for a period of time calculated to desorb a percentage of the adsorbed ammonia. The period will typically depend on conditions affecting feed forward control, such as the exhaust gas flow rate and NOx concentration. Preferably, the recovery period is calculated to desorb from about 10 to about 90% of the adsorbed ammonia, more preferably from about 25 to about 75% of the adsorbed ammonia, most preferably from about 40 to about 60% of the adsorbed ammonia. It is desirable to leave some ammonia in the reactor so that the buffering capacity acts against both over and underestimates of the optimal ammonia feed rate.

After the ammonia slip recovery cycle is completed, the process 50 returns to normal operation state 54, During the recovery process, the NOx sensor reading is expected to decrease to a minimum level. That minimum is expected to be typical of near optimal NOx conversion. A subsequent significant departure from that minimum can be used to trigger a transition from the normal operation state 54 to the unknown state 52. In one embodiment, the trigger corresponds to an increase in the NOx sensor reading of at least about 25%, in another embodiment, an increase of at least about 50%, and in a further embodiment, at least about 100%.

The NOx breakthrough recovery state 60 can be analogous to the ammonia slip recovery state 58 and involve restoring the SCR reactor's buffering capacity. This means providing an excess of ammonia to create a reservoir of ammonia in the reactor or, in the less common circumstance where buffering is provided by NOx adsorption, to remove a portion of the adsorbed NOx.

The ammonia slip recovery and NOx breakthrough recovery cycles can include an update to the feed forward control objective. For example, the control objective may include a target mole ratio between ammonia and NOx and the recovery cycle may include updating that target mole ratio. After ammonia slip, the mole ratio would be reduced. After NOx breakthrough, the mole ratio would be increased.

The target mole ratio or related quantity can be allowed to vary with the state of the system. For example, it may have a dependence on one or more of exhaust gas temperature, exhaust flow rate, SCR reactor temperature, and the rate at which the SCR reactor temperature is changing. The target mole ratio can vary either continuously with respect to these variables or discontinuous. An example of a continuous relationship would be a polynomial dependence between the target mole ratio and the variables. A discontinuous relationship would be a set of mole ratios each corresponding to a different parameter range. The parameter ranges can include, for example, one or more of exhaust gas temperature ranges, SCR reactor temperature ranges, and torque/speed ranges.

A preferred way of forming a relationship between a mole ratio and operating conditions is structuring the relationship as a learning probabilistic model. Feed back in terms of ammonia slip and NOx breakthrough, or the non-occurrence thereof during significant periods, can be used to generate training examples. With sufficient training data, the model can predict the mole ratio that is least likely to result in ammonia slip or NOx breakthrough.

A learning probabilistic model can be, for example, a decision graph, a support vector machines, a Bayesian belief network, or a neural network. Application of a learning probabilistic model involves selecting a model space, obtaining training data, and searching the model space for a model consistent with the training data. The model space is chosen so that there is a high probability that either the actual relationship between inputs and outputs or a close approximation thereto is in the model space. The choice of a search algorithm depends on the model type. Commonly used search algorithms are generally sufficient to find a model whose match to the data is reasonably good within the limits of the model space.

In one embodiment, a decision graph is employed to model the relationship between vehicle operating conditions and preferred mole ratio of ammonia to NOx. Decision graphs are composed of one or more, generally a plurality, of decision nodes and a plurality of leaf nodes. Decision graphs classify operating conditions by sorting them down a tree structure from a root decision node to a leaf node. The graphs branch at decision nodes, which represents tests of operating conditions, e.g., whether a temperature is above or below a certain value.

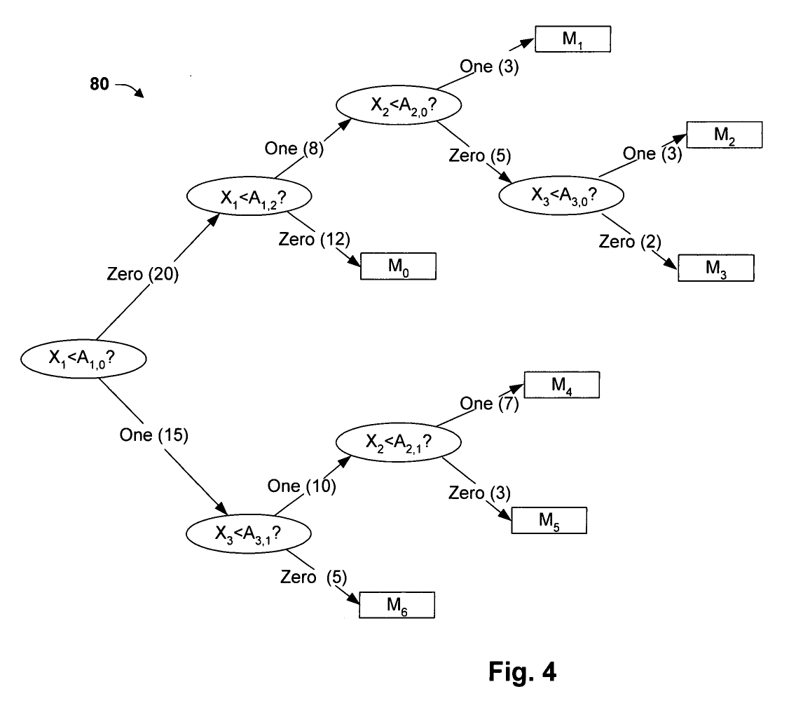

FIG. 4 gives an exemplary decision tree 80 in accordance with this embodiment. Decision trees are a special case of decision graphs. A decision tree is a decision graph in which each node has no more than one directly descending parent node. The decision tree 80 contains dependencies on tests of operating conditions Xᵢ. The operating conditions tested are, for example, the SCR reactor temperature, the derivative of the SCR reactor temperature, and the exhaust gas flow rate. Decision nodes can have multiple branches, but in the present example all the branches are restricted to binary branches. The critical values, A_{i,j}, used in the branches are determined as part of the decision tree learning process. The numbers in parenthesis following each test give hypothetical numbers of training examples sorted down the corresponding branch. The value in each leaf node, Mₖ, is the average mole ratio for all the training examples sorting to that node.

Suitable algorithms for building decision trees include the ID3 algorithm, the C4.5 algorithm, and Bayesian learning algorithms. Most decision tree building algorithms use a top down greedy approach to search through the universe of all possible decision trees for one that accurately classifies examples. The algorithms begin by asking which attribute should be tested first and answer the question by selecting the attribute that, in and of itself, best classifies the training examples in a statistical sense. A branch is created for each possible value of the attribute and a new node is placed at the end of each branch. The algorithm repeats at each of the new nodes using only the training examples that would be sorted to that node.

Operating conditions can be expressed as continuous or discrete variables. Where some of the operating condition are continuous variables, part of the process of selecting the operating condition that best classifies the data is selecting a value for each continuous operating condition against which to compare each training example. This can be accomplished, for example, with a gradient search starting from several randomly chosen initial values. The same operating condition can be tested at several decision nodes, with the operating condition value against which each training example is compared differing from one node to another.

When building a decision tree, steps are taken to avoid over-fitting the data. When data is over-fit, the model begins to capture random variations or noise that is unique to the training data. Over-fitting degrades the performance of the model when applied to items outside the training set. Over-fitting is avoided by either limiting the size of the tree or pruning the tree after its initial growth. In either case, the approach to avoiding over-fitting the data can be based on one or more of the following: a distinct set of training examples to evaluate the utility of certain branches; a statistical test to determine whether a particular branch is likely to improve the model fit outside of the training set; or an explicit measure of the complexity of a tree, whereby nodes are removed or avoided to limit the complexity.

A Bayesian algorithm can be employed to learn a decision tree. A Bayesian algorithm for learning decision trees involves assigning scores to various possible tree structures. For example, a Bayesian algorithm can proceed as follows:
1. Begin with one leaf node.
2. Score the current tree structure.
3. For every possible decision tree that can be generated by replacing a leaf node with a binary split of the data based on one of the user characteristics: Calculate a score for the possible structure.
4. If the best score from step 3 is better than the current score, make the corresponding possible structure the current structure and go to step 2.
5. Return the current structure. For discrete variables, binary splits of the data are constructed by making one branch for a particular variable value and another branch for all other possible values for that variable. Binary splits for continuous variables can be accomplished, for example, by considering a finite set of possible split values, or by conducting a gradient search.

In a Bayesian algorithm, the score is the posterior probability, or an approximation thereto, of the tree structure being correct given the observed data. The posterior probability is given by:
p(T^{h}|D)=c×p(D|T^{h})p(T^{h})
where T^{h} is the hypothesized tree structure, D is the observed data, and c is a constant that is independent of tree structure and can therefore be ignored. p(D|T^{h}) is the probability of observing a set of data given a particular tree structure. The data-independent probability of various tree structures, p(T^{h}), can be taken as one (all structures equally probable) or can be given some functionality that favors simple trees. For example, p(T^{h}) can be given by:
p(T^{h})=κⁿ
where n is the number of leaf nodes and κ is a number such that 0<κ<1.

The probability of observing a set of data given a particular tree structure, p(D|T^{h}), is taken as the product of the probabilities of observing each of the individual training examples. The probability of training example is determined by sorting it down the tree to a leaf node. The probability for the training example can be taken as the fraction of all data points sorting to that leaf node that are within some value, such as 0.01, of the mole ratio for the training example. Alternatively, a MAP method, such as Dirichlet priors, can be employed to generate probability estimates for particular observations.

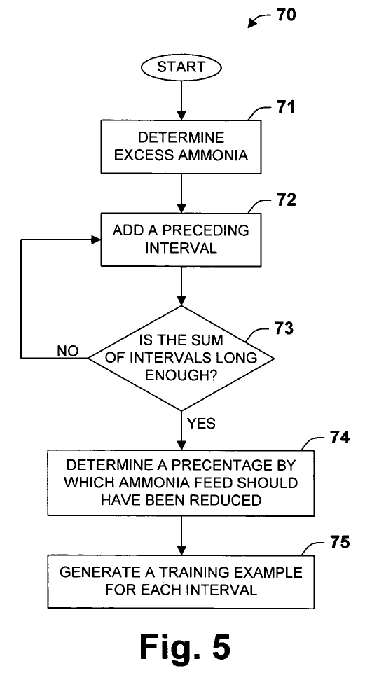

Laboratory experiments or computer simulation can be used to generate an initial set of training data. FIG. 5 illustrates a procedure 70 for generating new training examples. The procedure starts at block 71 following the occurrence of ammonia slip or NOx breakthrough. Block 71 involves determining the excess or shortage of ammonia delivered to the SCR reactor. In the case of ammonia slip, the excess is the difference between the amount of ammonia required to saturate the SCR reactor at the current temperature and ammonia partial pressure and the amount of ammonia ideally adsorbed, e.g., 50% of the amount required to saturate.

Block 72 identifies a preceding interval of relatively constant operating conditions. Historical data is examined beginning at a time, To, which is the time ammonia slip or NOx breakthrough was detected less the detector response time and less the residence time for the SCR reactor based on the prevailing exhaust gas flow rate. A relatively constant period is defined in terms of no change in target mole ratio and limited change in the monitored operating conditions. A limit on a change in an operating condition is, for example, a requirement that the SCR reactor temperature change by no more than 10° C. during the interval.

Block 73 determines whether the period is long enough to explain the excess or deficit. For example, if the excess of ammonia was greater than the total amount of ammonia delivered during the interval plus ihe expected amount of ammonia desorption due to any temperature and ammonia partial pressure change, then the interval is too short. If the interval is too short the process returns to step 72 to add another preceding interval.

Block 74 involves determining the total amount of ammonia delivered during the selected intervals. Comparing the total amount to the excess or deficit permits calculation of a percentage by which the mole ratio should have been different to avoid the excess or deficit. The adjusted mole ratio, in combination with averaged values for the operating conditions within each interval, becomes a training example in block 75. Where multiple preceding intervals were selected the mole ratio adjustment is applied to each interval and each interval becomes a separate training example. The training examples can be weighted by interval duration.

The optimal mole ratio may change over time. One way to account for this is to include hours of operation as an independent variable. Another is to gradually discard old training examples. Proliferation of training examples may become an issue in any case. When it does, examples can be selectively combined or discarded.

The example just given may be sensitive to estimates of the adsorption capacity of the SCR reactor and that capacity may change over time or depart from factory specifications. In one embodiment, the control system has the capability to measure the adsorption capacity. With the reactor at operating temperature, the ammonia feed can be stopped until the conversion of NOx has dropped to essentially zero. Ammonia feed can than be commenced at a high rate, for example twice the estimated requirement, and the reactor monitored until ammonia slip occurs. The excess of the ammonia delivered over the estimated requirement is the adsorption capacity at the prevailing temperature and ammonia partial pressure. The adsorption test can be manually initiated, initiated periodically, or initiated in response to the model failing to meet a performance standard.

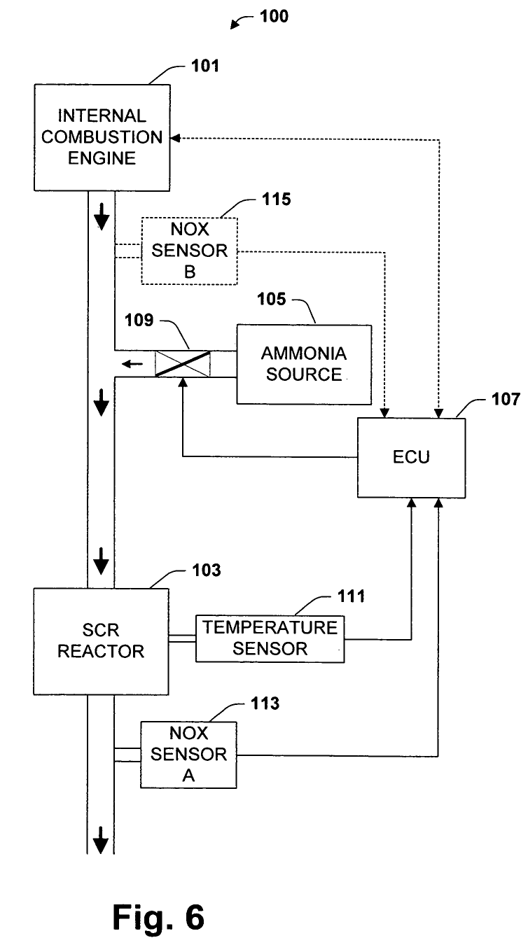

FIG. 6 illustrates an exemplary system 100 that can implement the present invention. The system 100 includes an internal combustion engine 101 producing exhaust, a SCR reactor 103 for treating the exhaust, an ammonia source 105, an engine control unit 107 for controlling the internal combustion engine 101 and the feed rate of ammonia from the ammonia source 105 through a valve 109, a temperature sensor 111 for sensing the temperature of the SCR reactor 103, and an NOx sensor A 113 downstream of the SCR reactor for use in feedback control. Optionally, the system 100 also includes an NOx sensor B 115 for measuring the NOx concentration in the exhaust.

The internal combustion engine 101 is typically mounted on a vehicle and powered by a fossil fuel such as diesel, gasoline, natural gas, or propane. The engine 101 burns the fuel and produces and exhaust comprising NOx. NOₓ includes, without limitation, NO, NO₂, N₂O, and N₂O₂.

The SCR reactor 103 treats the exhaust to remove NOx. The SCR reactor contains a catalyst optionally combined with or serving as an adsorbant. The catalyst is for a reaction such as:
4NO+4NH₃+O₂ [symbol] 4N₂+6H₂O
Catalysts for this reaction will also reduce other species of NOx. Examples of suitable catalysts include oxides of metals such as Cu, Zn, V, Cr, Al; Ti, Mn, Co, Fe, Ni, Pd, Pt, Rh, Rd, Mo, W, and Ce, zeolites, such as ZSM-5 or ZSM-11, substitutes with metal ions such as cations of Cu, Co, Ag, Zn, or Pt, and activated carbon. A preferred catalyst is a combination of TiO₂, with one or more of WO₃, V₂O₅, and MoO₃, for example about 70 to about 95% by weight TiO₂, about 5 to about 20% by weight WO₃ and/or MoO₃, and 0 to about 5% by weight V₂O₃. Catalysts of this type are commercially available and can be tailored by the manufacturer for specific applications. The typical temperature range in which these catalysts are effective is from about 230 to about 500° C. If the temperature is too high, the ammonia decomposes before reducing NOx.

In addition to any catalytic function, an adsorbant can add buffering capacity to the SCR reactor 103. If the NOx rate in the exhaust increases suddenly and before the ammonia supply rate is correspondingly increased, adsorbed ammonia in the reactor can provide the required reductant. If the ammonia feed rate is in excess of the NOx rate, the excess ammonia can be adsorbed, at least until the catalyst/adsorbant bed reaches saturation. Buffering is typically through ammonia adsorption, although NOx adsorption can also provide buffering. Adsorption is the preferential partitioning of a substance from the gas phase to the surface of a solid. Adsorption can be chemical or physical.

The adsorbant can be any suitable material. Examples of adsorbants are molecular sieves, alumina, silica, and activated carbon. Further examples are oxides, carbonates, and hydroxides of alkaline earth metals such as Mg, Ca, Sr, and Be or alkali metals such as K or Ce. Still further examples include metal phosphates, such as phoshates of titanium and zirconium.

Molecular sieves are materials having a crystalline structure that defines internal cavities and interconnecting pores of regular size. Zeolites are the most common example. Zeolites have crystalline structures generally based on atoms tetrahedrally bonded to each other with oxygen bridges. The atoms are most commonly aluminum and silicon (giving aluminosilicates), but P, Ga, Ge, B, Be, and other atoms can also make up the tetrahedral framework. The properties of a zeolite may be modified by ion exchange, for example with a rare earth metal or chromium. While the selection of an adsorbant depends on such factors as the desired adsorption temperature and the desorption method, preferred zeolites generally include rare earth zeolites, faujisites, and Thomsonite. Rare earth zeolites are zeolites that have been extensively (i.e., at least about 50%) or fully ion exchanged with a rare earth metal, such as lanthanum.

The catalyst and adsorbant are typically combined with a binder and either formed into a self-supporting structure or applied as a coating over an inert substrate. A binder can be, for example, a clay, a silicate, or a cement. Portland cement can be used to bind molecular sieve crystals. Generally, the adsorbant is most effective when a minimum of binder is used. Preferably, the adsorbant bed contains from about 3 to about 20% binder, more preferably from about 3 to about 12%, most preferably from about 3 to about 8%.

The SCR reactor can have any suitable structure. Suitable structures can include monoliths, layered structures having two-dimensional passages, as between sheets or screens, and packed beds. Monolith passages can have any suitable cross section, including, for example, round, hexagonal, or triangular passages. Sheets or screens can be layer in any suitable fashion including, for example, stacking, rolling, or arraying about a central axis. Packed beds can be formed with pellets of the adsorbant, preferably held together with a binder or sintered to form a cohesive mass.

Preferably, the SCR reactor 103 has a large adsorption capacity on a unit volume basis. Factors affecting the adsorption capacity of the SCR reactor 103 include the amount of adsorbant per unit volume, the physical availability of the adsorbant, and the adsorption capacity of the adsorbant per unit mass. In one embodiment, the SCR reactor comprises an adsorbant/catalyst bed comprising at least about 20% adsorbant by volume, in another embodiment, at least about 35% adsorbant by volume, in a further embodiment, at least about 50% adsorbant by volume. Preferably at 350° C. and one atmosphere adsorbant partial pressure the adsorbant/catalyst bed can take up at least about 3% adsorbant by weight, more preferably at least about 5% adsorbant by weight, still more preferably at least about 10% adsorbant by weight.

The structure of the SCR reactor 103 affects the utilization of the adsorbant, particularly when the reactor 103 is heavily loaded with an adsorbant having narrow pores, such as a molecular sieve. For example, where the structure is a monolith, the gases may not diffuse at an effective rate through the narrow pores of the molecular sieve into the depths of the walls and only the outer surface of the walls may provide useful adsorption capacity

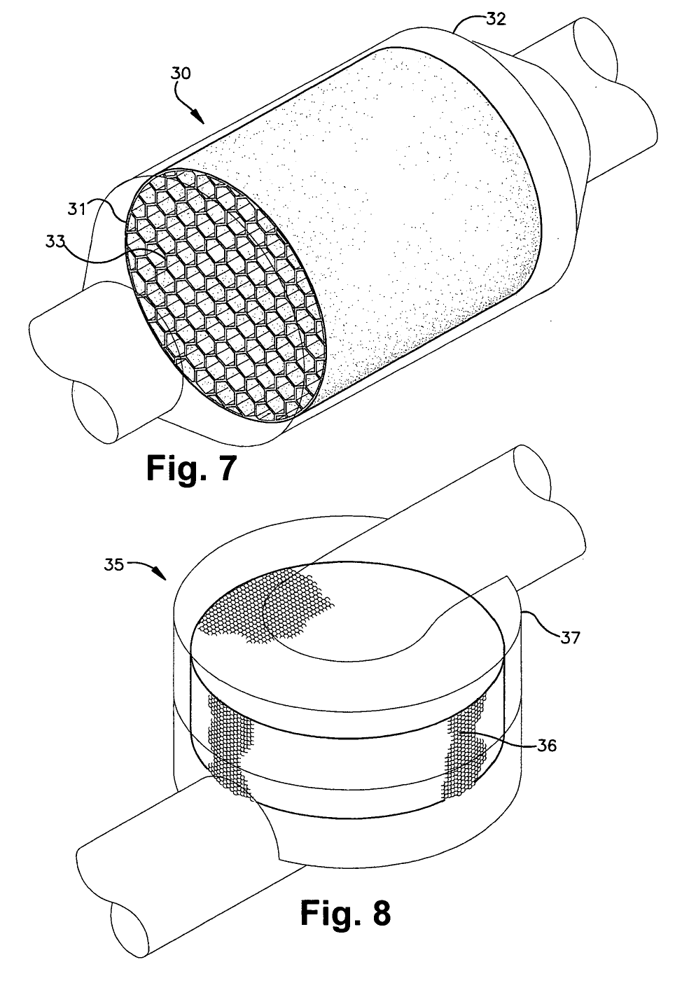

FIG. 7 illustrates an adsorber 30 with a design for improving the utilization of a molecular sieve adsorbant. The substrate 30 comprises a monolith 31 within a housing 32. The monolith 31 is preferably a self-supporting structure without an inert substrate. The monolith can be cast or extruded. Casting may be accomplished by pressing a coarse mixture into a mold followed by curing or filling the mold with small pellets and sintering them into a cohesive mass. Extrusion can be carried out in a similar fashion with heat applied at the point of extrusion to cure the binder or sinter the pellets. The walls 33 of the substrate 30 have a macro-porous structure, whereby the diffusion path length from the macro-pores to the centers of the pellets is substantially less than the diffusion path length from the channels to the centers of the walls. Because the monolith 31 lacks an inert substrate, it comprises a large fraction of adsorbant by weight. Preferably, the walls of the monolith, exclusive of the channel volume and exclusive of any pores having an effective diameter less than 100 nm (an effective diameter being defined with reference to mercury porosimetry) have a void volume fraction of at least about 0.2, more preferably at least about 0.3, still more preferably at least about 0.4.

FIG. 8 illustrates an adsorber 35 comprising a cohesive mass of pellets 36 in a housing 37. Loose pellets in a packed bed have a tendency to erode when mounted on a vehicle. The adsorber 35 mitigates this problem by forming the pellets into a cohesive mass, either by sintering the pellets together or mixing them with a binder. The individual pellets are preferably themselves made up of smaller particles held together by a binder or a sintering process. The spaces between the pellets correspond to the channels of the adsorber 30 and the voids in the pellets correspond to the voids in the walls of the adsorber 30. The comments regarding preferred composition and void sizes for the adsorber 30 apply to the adsorber 35. The adsorber 35 is provided in a pancake design. A pancake design gives a large cross-sectional area in the direction of flow and thereby reduces the pressure drop for a given bed volume.

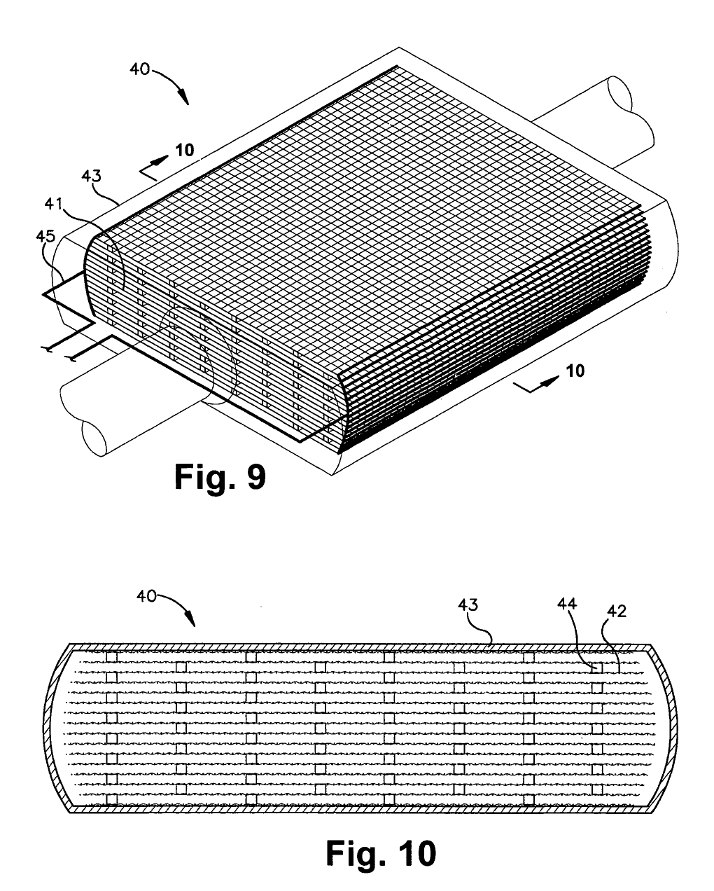

FIGS. 9 and 10 illustrates a substrate 40 in the form of a stack 41 of coated metal screens 42 in a housing 43. The adsorbant, which can be a molecular sieve, forms a coating over the screens 42. Exhaust flows between the screens 42. The spacing between the screens is controlled by spacers 44. The openings in the screens 42 provide additional surface area for the adsorbant. Electrical leads 45 are connected to the screens along either side of the adsorbent bed. By connecting a power source to the electrical leads 45, the substrate 40 can be heated to reduce the warm-up time of the SCR reactor 103.

The ammonia source 105 can be of any suitable type and can supply the ammonia in any suitable form, including for example, as liquid ammonia, urea, ammonium bicarbonate, or ammonium carbomate. The ammonia source can be a pressure vessel, a liquid tank, or an ammonia plant. An ammonia plant can generate ammonia by reaction between N₂ and H₂ or between NO and H₂. Whether or not an ammonia plant is used, the ammonia can also be stored on an adsorbant bed. Preferably adsorption takes place at a reduced temperature and desorption is driven by heating. The system 100 is typical in that it assumes the ammonia source maintains a certain pressure of ammonia and that the ammonia flow rate can be controlled by valve 109. The valve 109 can control the flow of ammonia by throttling, although preferably the flow rate is controlled by rapidly opening and closing the valve (i.e. via PWM control), the flow rate being in proportion to the time the valve spends open.

The temperature sensor 111 can be of any suitable type. Suitable types may include thermocouples, resistance temperature detectors, and thermistors. The temperature sensor 111 can be used to determine whether the SCR reactor 103 is hot enough to react ammonia or so hot that it would simply decompose ammonia. It can also be used in estimating adsorption rates, desorption rates, and adsorption capacity for the SCR reactor. The optimal mole ratio for feed forward control may be made dependent on readings from the temperature sensor 111.

The NOx sensor A 113 can also be of any suitable type, including for example an electrochemical sensor or a chemiluminescent sensor. A suitable sensor is manufactured by NGK Insulators, Ltd. While selectivity can be improved with branching diffusion chambers and catalysts, many common NOx sensors suitable for exhaust system application are cross-sensitive to ammonia, and the invention is particularly adapted to these types of sensors. The optional NOx sensor B 115 can be of the same type as the NOx sensor A 113. The NOx sensor B 115 is positioned to provide starting NOx concentration for use in feed forward control.

The enginecontrol unit 107 provides feed forward control over the ammonia supply rate. Feed forward control generally involves determining or estimating the NOx rate in the exhaust and calculating an ammonia feed rate that will give a target mole ratio to the SCR reactor 103. The NOx rate is the product of NOx concentration in the exhaust and the exhaust gas flow rate. Where NOx concentration is not measured, it can be estimated from information such as engine RPM, temperature, and torque. Exhaust flow rate can also be estimated, measured directly, or measured indirectly. Indirect ways of measuring the exhaust flow rate include measuring either the rate of air intake by the engine and/or measuring the rate of fuel intake of the engine and calculating the exhaust flow rate from this information together with other information like the A/F ratio of t the engine.

The invention has been shown and described with respect to certain aspects, examples, and embodiments. While a particular feature of the invention may have been disclosed with respect to only one of several aspects, examples, or embodiments, the feature may be combined with one or more other features of the other aspects, examples, or embodiments as may be advantageous for any given or particular application.

1. A method of controlling the feed rate of ammonia to an SCR reactor, comprising:
setting an ammonia feed rate;
providing a discrete pulse in the feed rate;
analyzing the output of an NOx sensor downstream of the SCR reactor within a fixed period of time following the pulse to determine whether ammonia slip is occurring; and
reducing the feed rate if ammonia slip is occurring.

2. A vehicle comprising an exhaust system implementing the method of claim 1.

3. The method of claim 1, wherein the SCR reactor is part of a vehicle exhaust system.

4. The method of claim 3, wherein the discrete pulse comprises a temporary increase in the ammonia feed rate.

5. The method of claim 3, wherein the discrete pulse comprises a temporary decrease in the ammonia feed rate.

6. The method of claim 3, wherein the NOx sensor is cross-sensitive with ammonia.

7. The method of claim 3, wherein the discrete pulse is provided over a period of no more than about one second.

8. The method of claim 3, wherein the fixed period is no more than about one second.

9. The method of claim 3, wherein the ammonia feed rate is set based on an approximation of the amount of NOx in the exhaust.

10. The method of claim 3, wherein the ammonia feed rate is set based on a feed-forward control objective.

11. The method of claim 10, wherein the control objective is modified after detecting ammonia slip.

12. The method of claim 10, wherein the control objective is determined, at least in part, by a learning probabilistic model, which is trained using examples generated upon the occurrence of ammonia slip.

13. The method of claim 3, wherein the discrete pulse is provided upon detecting an increase in signal from the NOx sensor.

14. The method of claim 3, wherein the discrete pulse is provided periodically.

15. A method of controlling the feed rate of ammonia to an SCR reactor, comprising:
providing feed-forward control over the ammonia supply rate to the SCR reactor;
controlling the ammonia supply rate to the SCR reactor in a feed-forward mode wherein the ammonia is supplied based on an estimate of the SCR reactor's requirements for reducing NOx;
detecting ammonia slip;
entering an ammonia slip recovery mode in which the ammonia supply rate is reduced relative to the feed-forward mode over a limited period of time to reduce the amount of ammonia and/or increase the amount of NOx adsorbed in the SCR reactor; and
returning to the feed-forward mode.

16. A vehicle comprising an exhaust system implementing the method of claim 15.

17. The method of claim 15, wherein the SCR reactor is part of a vehicle exhaust system.

18. The method of claim 17, wherein the SCR reactor comprises a molecular sieve.

19. The method of claim 17, wherein the SCR reactor comprises at least about 50% adsorbant by weight.

20. The method of claim 17, wherein detecting ammonia slip comprises providing a pulse in the ammonia feed rate.

21. The method of claim 17, wherein the ammonia slip is detected by a NOx sensor cross-sensitive with ammonia.

22. A method of controlling the feed rate of ammonia to an SCR reactor, comprising:
providing feed-forward control over the ammonia supply rate to the SCR reactor;
controlling the ammonia supply rate to the SCR reactor in a feed-forward mode wherein the ammonia is supplied based on an estimate of the SCR reactor's requirements for reducing the NOx;
detecting NOx breakthrough;
entering an NOx breakthrough recovery mode in which the ammonia supply rate is increased relative to the feed-forward mode over a limited period of time to increase the amount of ammonia and/or reduce the amount of NOx adsorbed in the SCR reactor; and
returning to the feed-forward mode.

23. A vehicle comprising an exhaust system implementing the method of claim 22.

24. The method of claim 22, wherein the SCR reactor is part of a vehicle exhaust system.

25. The method of claim 24, wherein the SCR reactor comprises a molecular sieve.

26. The method of claim 24, wherein the SCR reactor comprises at least about 50% adsorbant by weight.

27. The method of claim 24, wherein detecting NOx breakthrough comprises providing a pulse in the ammonia feed rate.

28. The method of claim 24, wherein NOx breakthrough is detected by a NOx sensor cross-sensitive with ammonia.

29. A method of controlling the feed rate of ammonia to an SCR reactor, comprising:
providing feed-forward control over the ammonia supply rate to the SCR reactor based, at least in part, on a learning probabilistic model;
generating training examples for the learning probabilistic model based on events selected from the group consisting of occurrences of NOx breakthrough, periods of non-occurrence of NOx breakthrough, and ammonia slip, periods of non-occurrence of ammonia slip; and
updating the model using the training examples.

30. The method of claim 29, wherein the SCR reactor is part of a vehicle exhaust system.

31. A vehicle comprising an exhaust system implementing the method of claim 29.

32. A vehicle, comprising:
an engine that produces exhaust;
an SCR reactor for reducing NOx in the exhaust; and
a controller adapted to control a supply rate of ammonia to the SCR reactor;
wherein the vehicle is adapted to measure an ammonia adsorption capacity for the SCR reactor.

33. The vehicle of claim 32, wherein the adaptation to measure an ammonia adsorption capacity for the SCR reactor comprises a mode for the controller wherein the ammonia feed is stopped until the SCR reactor is essentially ammonia-free and then an excess of ammonia is supplied until ammonia slip is detected.

34. The vehicle of claim 32, wherein the adaptation to measure an ammonia adsorption capacity for the SCR reactor comprises a mode for the controller wherein the SCR reactor is under-supplied with ammonia for a period following an occurrence of ammonia slip, the period continuing at least until NOx breakthrough is detected.
